(19) United States
(12) Patent Application Publication
(10) Pub. No.: US 2025/0036847 A1
(43) Pub. Date: Jan. 30, 2025

(54) APPLICATION OF MACHINE LEARNING TECHNIQUES TO INTELLECTUAL PROPERTY (IP) BASED DATA STRUCTURE FOR FUNCTIONAL SAFETY ANALYSIS

(71) Applicant: Synopsys, Inc., Sunnyvale, CA (US)

(72) Inventors: Vladimir LITOVTCHENKO, Ebersberg (DE); Shivakumar Shankar CHONNAD, San Jose, CA (US); Radu Horia IACOB, Hillsboro, OR (US)

(21) Appl. No.: 18/226,190

(22) Filed: Jul. 25, 2023

(51) Int. Cl. G06F 30/398; G06F 30/3323

(52) U.S. Cl. CPC G06F 30/398; G06F 30/3323; G06F 2119/02

(57) ABSTRACT

The present disclosure is related to systems and methods for application of machine learning techniques to functional safety analyses of IP cores used in chip designs, to facilitate efficiency, accuracy and completeness of the chip designs. In embodiments of the present disclosure, a functional safety system receives input data for a chip design, and profiles the input data to identify a plurality of IP cores present in the design. The functional safety system determines a match of at least one identified IP core with an IP core present in a functional safety related data structure. The functional safety system then conducts one or more safety analyses on the identified IP core and generates a safety report accordingly.

### TECHNICAL FIELD

The present disclosure generally relates to an electronic design automation (EDA) system. In particular, the present disclosure relates to machine learning technology for a functional safety system.

### BACKGROUND

Functional safety is a type of development for automotive integrated circuits and systems that addresses the ability to mitigate a risk posed from a fault of an automotive integrated circuit while in use. That is, even though the circuit components are free of defects when manufactured, and may be fully functional when mounted in a vehicle, there may still occur a situation while the vehicle is in use that causes a random fault in the circuit. For example, a vehicle may drive under a high voltage power line with high intensity electric fields, or through an area with higher than expected radiation. This external environment can induce unexpected effects into the automotive circuit(s), potentially leading to one or more faults in the functionality of the circuit(s) further noted as random hardware faults (RHFs). This random fault may create a failure of a vehicular system, leading to errors in the functionality of a vehicular system, which may create a risky or unsafe situation for the vehicle passengers, driver, other participants in traffic, environments, etc.

### SUMMARY

In one example, a computer-implemented method of the present disclosure includes receiving identifying information for an IP core. The identified information for the IP core includes at least one of: an IP tag, or a pointer to a location where information for the IP core is stored in a data structure. The computer-implemented method further includes determining at least one safety related parameter for the IP is present in the data structure. The method further includes determining the at least one safety related parameter for the IP matches the IP information in the data structure within a predefined threshold, using the IP information in the data structure to conduct one or more safety analyses, and generating a safety report with a result of the one or more safety analyses.

In another example, a computer-implemented method of the present disclosure includes receiving input data for a chip design, and profiling the input data to identify a plurality of IP cores present in the design. The method then continues with determining a match of at least one identified IP core with an IP core present in a functional safety related data structure. The method further includes conducting one or more safety analyses on the identified IP core and generating a safety report accordingly.

In a further example, a functional safety system of the present disclosure includes a memory storing instructions, and a processor coupled with the memory to execute the instructions. The instructions, when executed, cause the processor to receive input data for a chip design, and profile the input data to identify a plurality of IP cores present in the design. The functional safety system determines a match of at least one identified IP core with an IP core present in a functional safety related data structure. The functional safety system then conducts one or more safety analyses on the identified IP core and generates a safety report accordingly.

### BRIEF DESCRIPTION OF THE DRAWINGS

The disclosure will be understood more fully from the detailed description given below and from the accompanying figures of embodiments of the disclosure. The figures are used to provide knowledge and understanding of embodiments of the disclosure and do not limit the scope of the disclosure to these specific embodiments. Furthermore, the figures are not necessarily drawn to scale.

FIG. 1 depicts an exemplary data structure, according to embodiments of the present disclosure.

FIG. 2 is a graphic illustrating an exemplary data structure of design blocks with functional safety features and failure modes in relation to hardware elements used for safety architecture implementation, according to embodiments of the present disclosure.

FIG. 3 depicts an exemplary simplified flow diagram for a functional safety system to use a safety related machine learning database to conduct one or more safety analyses based on matching data from the learning database, according to embodiments of the present disclosure.

FIG. 4 depicts an exemplary simplified flow diagram for a functional safety system to use a safety related machine learning database to conduct one or more safety analyses, as well as for machine learning and database storage, according to embodiments of the present disclosure.

FIG. 5 depicts an exemplary workflow for a functional safety system to learn new safety related information, according to embodiments of the present disclosure.

FIG. 6 depicts an exemplary workflow for a functional safety system to process a safety concept utilizing the machine learning database patterns, according to embodiments of the present disclosure.

FIG. 7 depicts an exemplary simplified graphic of operations performed by a functional safety-related system while performing a safety analysis of an IP core of the present disclosure.

FIG. 8 depicts a flowchart of various processes used during the design and manufacture of an integrated circuit in accordance with some embodiments of the present disclosure.

FIG. 9 depicts a diagram of an example functional safety-related computer system in which embodiments of the present disclosure may operate.

### DETAILED DESCRIPTION

Aspects of the present disclosure relate to an application of machine learning techniques to IP core based data structures for functional safety analysis. This concept is applicable to an implementation of any size, including electronic systems that incorporate multiple hardware and software IP core components.

An intellectual property core (IP core) is a functional block used to make a field-programmable gate array (FPGA) or application-specific integrated circuit for a product. Commonly used in semiconductors, an IP core is a reusable unit of logic or functionality or an integrated circuit (IC) layout design that may be developed for use as a building block in an IC design. An IP core may include a variety of hardware (HW) or software (SW) elements, or a combination of both.

In modern IC designs, an increasing number of system functionalities are integrated into single chips, known as a system-on-a-chip (SOC) design. Most SOCs incorporate a standard microprocessor and standardized functionalities, accommodating design reuse across multiple ICs by multiple vendors on a licensing basis. In these systems, pre-designed IP cores play a key role.

An IP core may be a standalone module that's part of a larger device or system, such as a processor or other complex IC. It incorporates electronic circuitry whose use is licensed by the original designer to other companies. Most IP cores are developed using hardware description languages (HDLs), like very high speed integrated circuit (VHSIC) HDL, Verilog, System Verilog or Verilog-AMS.

IP cores may support design reuse. Electronics engineers and designers use them to implement components of logic and ICs faster than they could otherwise. Since they accommodate repeated use of previously designed components, they contribute to the fast-paced development of new systems implemented in new technologies.

A soft core is the most flexible type of IP core since it can be customized to map to any process technology and reused for a wide range of applications. It can exist as a modifiable netlist, which is a list of the logic gates and associated interconnections making up the IC. It can also be provided as register transfer language (RTL) code.

An IP core can have many parameters, and numerous configurable combinations as permutations. Using multiple IP cores together in a system can result in millions of potential combinations of parameters. It is a manually intensive effort to create and maintain the results of functional safety analyses work products for each of the varied configurations. Further, it is impossible to know how a manual parameter change in one IP core will impact results of a functional safety analysis of the system as a whole, without a detailed manual check of various parameters and simulations. This is a time intensive, computing resource intensive, and error prone process. Further, integrating the functional safety related data of multiple IP cores into a SoC or sub-system functional safety analysis is a time intensive, computing resource intensive, and error prone process.

Embodiments of the present disclosure provide for some or all functional safety related parametric data of an IP core to be defined and stored into a dynamic data structure having linear and non-linear data types. As used herein, data elements in a linear data structure connect to each other sequentially, whereas data elements in a non-linear data structure connect to each other hierarchically. Linear circuits are those whose parameters are not changed, and whose outputs are linearly predictable as a result of inputs modified with a defined function. Non-linear circuits are those subject to changes in parameters and configurations such that the overall output is a function of the implementation influenced by the parameters. This functional safety related data can then be retrieved by one or more downstream functional safety software tools to perform functional safety analyses. Further, the functional safety software tools are trained to execute previously manual processes such as IP profiling, IP matching, and delta analysis. Further, the dynamic data structure for the functional safety related data can grow through a machine learning process and adapt to include additional or different functional safety related data of IPs. In this way, the data structure is updated with newer learnt data for future use. This data structure can be used for the development of vehicle systems with functional safety performance. The data from the database is analyzed through formulas and instructions provided by the International Organization for Standardization (ISO) 26262 standard guidelines, resulting in ease of analysis of failure modes.

Downstream functional safety software tools can then recall data from the dynamic data store and use the stored data to draw inferences from patterns and statistical models in the data for suitability for particular purposes, or matching. The data can be retrieved to perform functional safety analyses such as failure modes effects and diagnostic analysis (FMEDA), dependent failure analysis (DFA), fault tree analysis (FTA) etc.

FMEDA is a quantitative methodology for the detailed determination of random failure causes and their impact on a system, and it is used to determine the effects of the random failures and the effectiveness of the safety mechanisms implemented to detect and control these failures, in order to reduce or eliminate the potential risks resulting from such failures. FMEDA can further provide metrics that describe the functional safety performance of the system, in terms of capability for detection and control. Functional safety related data from the data structure can be used to implement further IP configurations to meet the safety requirements.

DFA is a method to determine if violation of a safety goal occurs between elements when a single root cause can lead to multiple elements to fail due to a variety of coupling factors (common cause failures), or when a failure of one element causes a dependent failure of another element (cascading failures). Dependent failures are not statistically independent, and impede the conditions of technical independence and freedom from interference. Dependent failures can include software failures.

Embodiments of the present disclosure also provide for IP hierarchical data to be used to perform functional safety analyses of complex SoCs and sub-systems, such as those deployed in vehicles. In addition, the present disclosure provides for training of the database to execute the tasks or to execute tasks that are currently accomplished manually, such as IP profiling, and other functions discussed in more detail below. Embodiments of the present disclosure further provide for a trainable database with data related to types of IP blocks, IP circuits, sub-circuits, and every sub element of a bigger circuit or system. These are constituent components for this system or subsystem.

For example, a system may include multiple sensors, each sensor associated with a processor that receives and analyzes information. Actuators at the other end of the chain receive commands from the processor according to the data received from the sensors and execute decisions made by the processors. In a vehicle, there may be hundreds of sensors and many actuators. Actuators will be any little or big electric motor control (lights, windshield wipers, wheels, etc.). In addition, a vehicle may have other safety systems such as vehicle stabilization control (to stabilize a vehicle when traveling over a slippery road), maintaining direction of car, lane assist technology, etc. This safety system will interpret the information received from the sensors (e.g., a gyroscope) and the speedometer and other instruments and process the information and make decision as to what measures are to be taken regarding the rotation of wheels, direction of wheels, etc. so that the vehicle is getting stabilized and doesn't slide sideways, maintains direction into a safe way, etc.

In order to mitigate risk from these unexpected situations caused by RHFs, there are diagnostic and control measures that can be put in place that preserve the safety goals that are required from a system during functionality in the field. These safety goals need to be preserved in all circumstances, including when random causes may initiate faults, failures, or errors in the system (e.g., a car should not accelerate unexpectedly when a driver is pressing the brake pedal). This functional safety development is done along with product development in the design phase, verified through simulations, and tested through various test procedures. Eventually a functional safety audit and assessment are conducted, and a functional safety certification is provided for that specific component, element, or system.

An automotive system may start with multiple blocks of intellectual property (IP) processor cores, and several safety goals at an element level. Multiple elements are combined into a subsystem. Multiple subsystems are then combined into a system that can accomplish numerous safety goals with hundreds of hardware blocks participating and working together.

In essence, functional safety takes a situation that occurs at random in the field, and analyzes the input information or the status of health of the system. If there are errors or other information that is not according to expectations, a hardware or software functional safety mechanism takes measurements and actions to avoid or mitigate a risk of violation of a safety goal. In current systems, the analysis of errors or faults of a system is conducted by a mostly manual inspection of thousands of lines of input data.

The present disclosure provides an advantage of using machine learning techniques to improve a workflow for functional safety components. By using machine learning, human error is reduced or eliminated completely, thus increasing an accuracy of the system. Further, an automated process can be conducted faster than a manual process, thus increasing an efficiency of the system. In addition, more complex systems can be analyzed and developed faster, thus increasing a capability of the system.

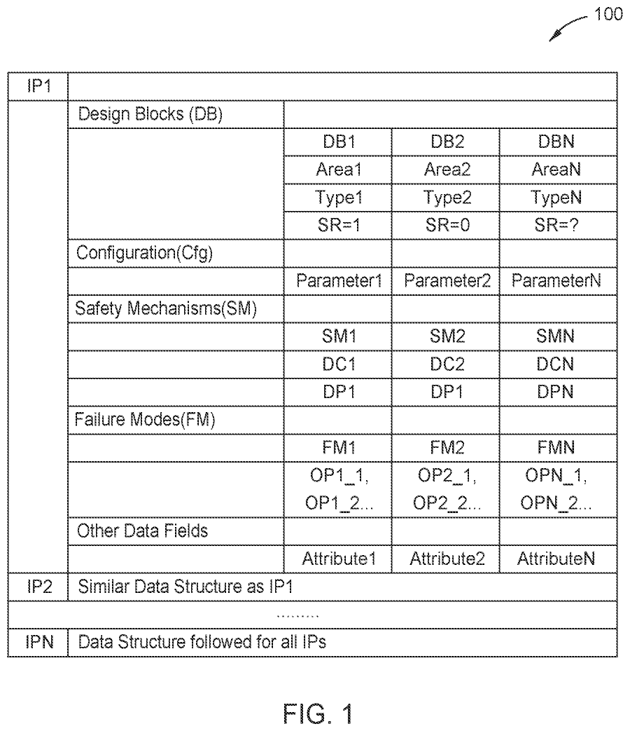

FIG. 1 depicts an exemplary data structure 100 of the present disclosure. In FIG. 1, different IP cores and corresponding parameters for each IP core are depicted. While some specific parameters are shown in the exemplary data structure 100 of FIG. 1, there may be fewer or additional configurable or non-configurable parameters in other embodiments of data structure 100. That is, a system may have a data structure that is more complex with many more IP cores, and/or parameters for each IP core. In some embodiments, all parameters that are specific to functional safety are stored in data structure 100. Data structure 100 of FIG. 1 may be stored in a database, such as a machine learning database.

In exemplary embodiments of data structure 100, there are linear and fixed data fields. All fields are accessible through a hierarchical dot convention, and/or other methods. That is, dot notation can be used to identify data at a specific level of the hierarchy, where a first part of a qualified data name identifies a parent object, and subsequent parts identify children along a hierarchical path.

The data structure 100 is also scalable through defaults and formulas. That is, default values may be used in some fields and formulas may be used to input values in other fields. Data structure 100 is also readable and writeable for sharing the IP functional safety data with other software tools for performing functional safety analyses of a broader manufactured system where the IP cores are used.

In exemplary data structure 100, IP1 is shown as having multiple partitions, referred to herein as design blocks (DB). The DBs are shown in exemplary FIG. 1 as DB1, DB2, and DBN, where N represents any positive integer value. Each design block further has an area, which can be a physical layout area on the SoC. In other embodiments, if the physical layout area is undetermined, then the area can refer to a number of transistors or logic gates for the design block. In addition, each design block has a signal type, which can be a digital, analog, or mixed signal. Further, each design block is noted as having a safety related (SR) role or not. For example, a value of SR=0 may denote that the design block is not safety related, whereas a value of SR=1 may denote that the design block is safety related. Moreover, in exemplary data structure 100, IP1 can include connectivity fields at a design block level, defining incoming connections and outgoing connections between the constituent design blocks that allow configuration of the data structure as a linked list, a tree, a graph, or a network, as needed to describe the functionality and topology of the IP component. The IP1 component itself may feature such connectivity fields that may connect IP1 to other IP components.

Further, each IP core can be configured with different parameters, such as whether the bus is 8 bits, 16 bits, 32 bits, 64 bits, or 128 bits. Some or all of these parameters may be configurable in various embodiments. The IP core can expand physically in terms of area or number of transistors, depending on this type of parameter, while preserving a similar functionality but with a higher capacity or higher speed.

An IP block may further have defined parameters for safety mechanisms (SM), which are mechanisms that are specifically related to safety, either internal to the IP, or external to the IP but part of a broader system that uses the IP core. For example, exemplary safety mechanisms of a vehicle may be an ability to detect lane departures, potential roadblocks, etc. In addition, each SM may have a diagnostic coverage (DC) value, which is a value representing a quantified ability of the SM to detect faults (e.g., an accuracy of detecting lane departure or roadblock for a traveling vehicle). Ideally, a set of safety mechanisms will be able to detect a high percentage of faults (close to 100%), but in some applications, the DC value may be 60-90% detected of all single-point faults or latent multiple-point faults.

Data structure 100 also includes information regarding Failure Modes (FM), which are specific to a design block. An IP's design block failure may be defined in different ways, with different observation points (OP). For example, a design block may fail if a vehicle doesn't achieve a designated speed, and thus enter a failure mode. In another example, a design block may fail if it is not able to perform under the minimum supply voltage, and thus enter a failure mode. In a further example, a failure mode may be defined by the inadvertent processing of an incorrect instruction input by a design block. That is, while the design block may have the ability to interpret the wrong instruction and correct it accordingly, or recognize the instruction as incorrect and cancel it, instead it may attempt to execute the incorrect instruction and enter an error state.

In various embodiments, the failure modes are described mostly at the interfaces. For example, if a comparator takes a wrong decision, it is expected that the read value will still be the same as an expected value. However, if an unexpected event has occurred internal to the comparator, it will provide a result that is unexpected or corrupted. One failure mode can be defined where the output of the comparator is not as expected, or is an inconsistent value. In this way, failure modes are associated with the components of an IP core, and with specific design blocks.

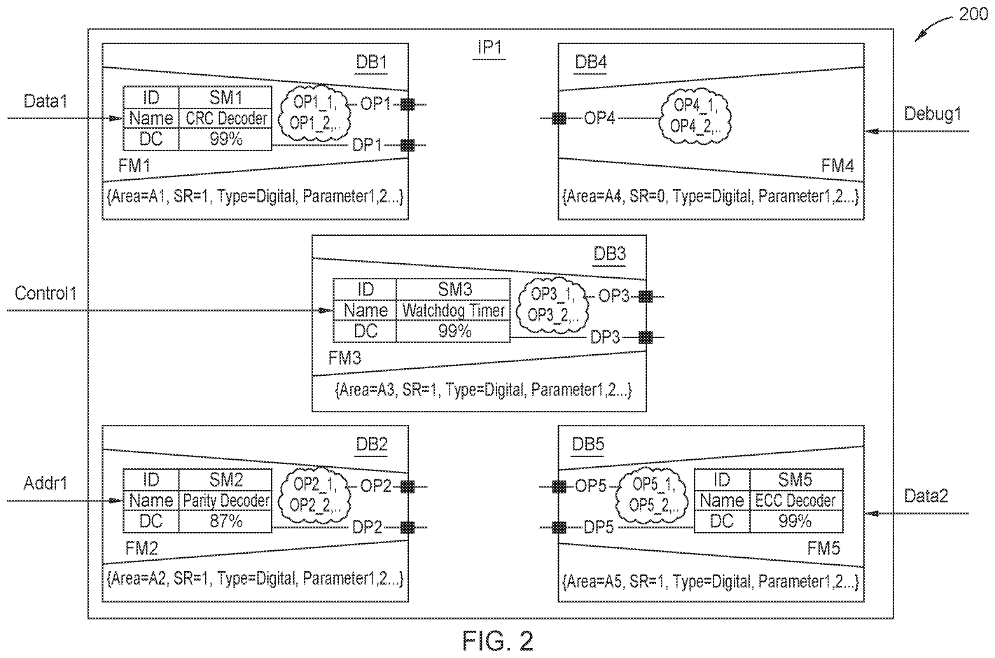

FIG. 2 is a graphic 200 illustrating an exemplary data structure of design blocks with functional safety features and failure modes for design blocks of an IP (such as IP1 of FIG. 1), in relation to hardware elements used for safety architecture implementation. Graphic 200 illustrates an example use of a data structure (such as data structure 100 of FIG. 1) with key functional safety related fields inside an IP. Each design block in graphic 200 has its unique fields of the data structure pre-canned as pragmas or parameters. The fields in the design blocks are matched to a corresponding data structure, such as a data structure in a machine learning database, when retrieved for matching purposes by a software tool. The IP concept depicted in graphic 200 is also applicable to sub-systems or SoCs.

In various embodiments, an IP (processor) core may have up to 60 unique design blocks. There are a corresponding total number of parameters, and a total number of functional safety related parameters for each design block. Moreover, for each design block of an IP core, multiple failure modes may be defined, each having a specific failure mode distribution (FMD) with respect to that design block. Thus, an FMD field may be defined for each FM within the IP core machine learning database. There can further be multiple safety mechanisms with their own diagnostic coverages for each design block. Safety mechanisms can also be combined to address failure modes from different design blocks.

In exemplary graphic 200 of FIG. 2, design block 1 (DB1) has an area of A1 (which can be any numeric value), has a safety related role and a designated safety related parameter SR1 (which is set to 1 in some embodiments), and is of a digital type. Further, DB1 receives incoming Data1. In various embodiments, Data1 is a generic input, and can come from a physical interface of the design block, or its conjugate block in a larger IP or SoC. Safety mechanism SM1 is identified in exemplary graphic 200 as a cyclic redundancy check (CRC) decoder and has a diagnostic coverage (DC) of 99%, meaning that 99% of faults occurring within the logic having failure mode 1 (FM1) can be detected by the safety mechanism SM1 of the design block DB1 of the IP. In other implementations, SM1 may be a different safety mechanism other than a CRC decoder, and/or have a different DC percentage.

Design block 2 (DB2) of graphic 200 is depicting as having an area of A2 (which can be any numeric value), has a safety related role and a designated safety related parameter SR2, and it is of a digital type. DB2 receives incoming address information Addr1. In some embodiments, Addr1 is a generic input that can be driven by an external CPU or any other host agent. Safety mechanism SM2 is identified as a Parity Decoder and has a diagnostic coverage of 87%, meaning that 87% of faults within failure mode 2 FM2 can be detected by the safety mechanism SM2 of the design block DB2 of the IP.

Design block 3 (DB3) of graphic 200 has an area of A3 (which can be any numeric value), has a Safety Related role and a designated safety related parameter SR3, and it is of a digital type. DB3 receives incoming control information Control1, which can be driven by any external host that interfaces with the design block. Safety mechanism SM3 is identified as a watchdog timer and has a diagnostic coverage (DC) of 99%, meaning that 99% of faults in the failure mode 3 FM3 can be detected by the safety mechanism SM3 of the design block of the IP.

Design block 4 (DB4) of graphic 200 has an area of A4 (which can be any numeric value), has a designated safety related parameter SR4, and it is of a digital type. DB4 also has a safety related role parameter of zero, which means the design block has a non-safety related role. DB4 receives incoming debug information Debug1, which can be a bit or bus driven by tapping one or more debug points in the implementation. DB4 is further associated with observation points OP4 and OP5 of the system controlled by the particular IP core.

Design block 5 (DB5) of graphic 200 has an area of A5 (which can be any numeric value), has a Safety Related role and a designated safety related parameter SR5, and it is of a digital type. DB5 receives incoming data Data2, which can be retrieved from a memory. Safety mechanism SM5 is identified as an error correction code (ECC) decoder and has a diagnostic coverage (DC) of 99%, meaning that 99% of faults within failure mode 5 FM5 can be detected by the safety mechanism SM5 of the design block of the IP.

In exemplary embodiments, all of the data depicted in graphic 200 of FIG. 2 is included in a machine learning database with a specific data structure. That is, the data structure is flexible enough to interconnect all of these parameters in a consistent way, yet still adaptive such that it can learn and update with new information. Thus, if a new design block is defined in a certain development that can be learned and included in the machine learning database and treated as knowledge data on the next development when this same type of design block is identified. For the next development, the design block will be treated as a known block, and information/parameters regarding that design block can be retrieved from the database and used directly by a safety related software tool. Further, IP core database may include component level functional safety performance metrics such as Single Point Fault Metric (SPFM), Latent Fault Metric (LFM) and Probabilistic Metric for random Hardware Failures (PMHF) that may be determined through a preliminary safety analysis and updated upon any changes made by the learning process to the IP core database, through the post safety analysis validation and learning step.

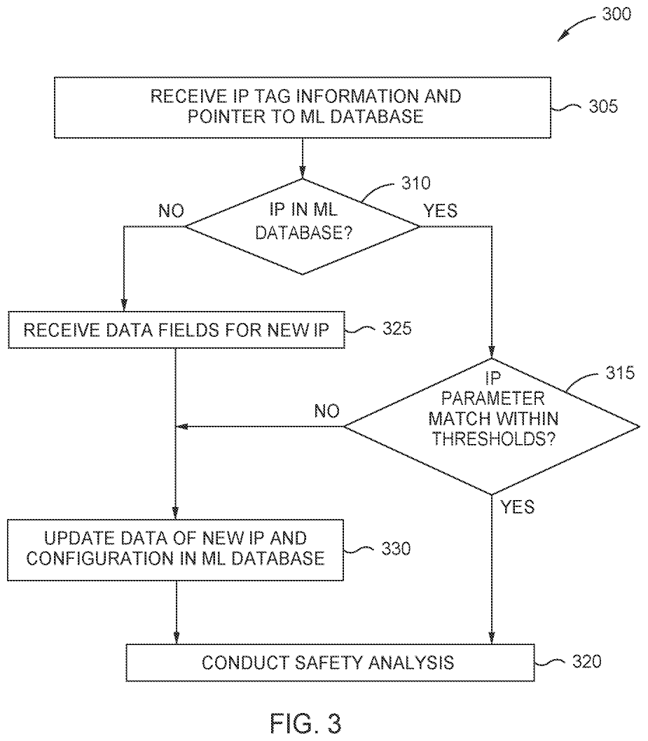

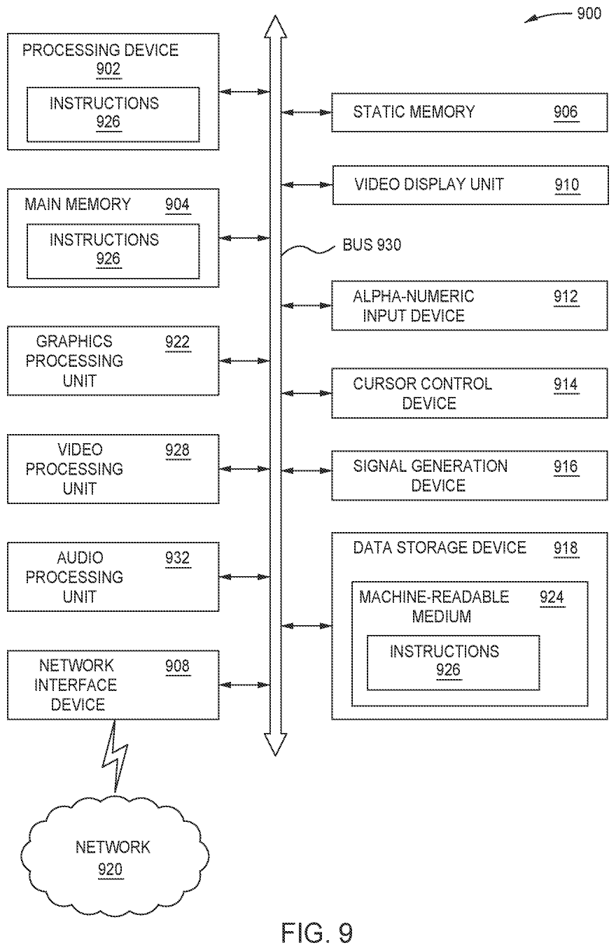

FIG. 3 depicts an exemplary simplified flow diagram 300 for a safety related software tool operating on a computing system (such as computing system 900 of FIG. 9), also referred to herein as a functional safety system, to use a safety related machine learning database to conduct one or more safety analyses. At 305, a computing system in communication with a machine learning database receives input data from a user interface, or another computing system (which may include a database). In various embodiments, the input data contains at least one of: information regarding an IP's tag information, and a pointer to a location of the IP's information in the machine learning database. In exemplary embodiments, IP tag information may contain any one or more of: information regarding a particular design block, safety mechanism, safety related parameter, or failure mode.

At 310, the computing system determines if the machine learning data related to the IP under analysis exists in the machine learning database by data profiling based on either the IP tag information, the machine learning database pointer, or both. If so, the computer system determines at 315 if the parameters of the IP under analysis match with the corresponding information in the database within a threshold amount (e.g., a predefined threshold). In some embodiments, all IP parameters need to match a threshold amount of 100%. In other embodiments, some or all IP parameters may only match within a threshold amount of 50-99%. In some embodiments, each particular parameter may have its own threshold amount. In other embodiments, all parameters have the same threshold amount. In some embodiments, the threshold amount for any one or more parameter is customizable by a user of the safety related software tool.

If the computing system determines that the received IP parameter(s) match those of the database within the threshold(s), then the system uses the data from the machine learning database to conduct one or more safety analyses at 320. Optionally, results of the safety analyses are then used to update the database, including the functional safety performance parameters of the IP within the context of the application, as needed. Further, in some embodiments, the computing system takes one or more further actions. The one or more further actions may be displaying some or all of the results of the safety analyses on a display, generating one or more reports with some or all of the results of the safety analyses, and/or generating one or more audio or visual alerts.

If the computing system determines at 310 that the IP does not exist in the machine learning database already, then the computing system intakes data fields for the IP under analysis as a new IP, and configuration information for the new IP, from a user interface at 325. The computing system generalizes the input data for the machine learning database to learn or adapt to the new information. In some embodiments, the computing system uses one or more machine learning techniques, such as principal component analysis, decision trees, or neural networks. The machine learning techniques can be combined together into an ensemble stacking method. In one example, principal component analysis is used to post-process input data to convert it into a database readable format with relevant features for safety analysis. That is, the computing system extracts features relevant for functional safety from general input data, and converts them into a format that is readable by the database.

A decision tree can be used to determine where the post-processed input data fits in based on type of design block (digital, analog, or mixed signal). The decision tree may also decide where the input component fits into a linear or non-linear data structure for the database. A neural network can identify and analyze the component's internal devices connections netlist and determine the functions of the circuit for that component. The principal component analysis, decision tree output, and neural network output can be combined using an ensemble stacking method to make up a final description of the component that is added to the database in a format suitable for the functional safety analysis.

Optionally, the system also reports delta results (a differential between the new information and previous information in the database) for a cross check. At 330, the computing system prepares updated data of the new IP and configuration, and communicates this updated data to the machine learning database, such that the information in the database can also be updated and referred to for future reuse. This updated information can then be used by a software application to conduct one or more safety analyses at 320. Optionally, results of the safety analyses are then used to update the database, including the functional safety performance parameters of the IP within the context of the application, as needed.

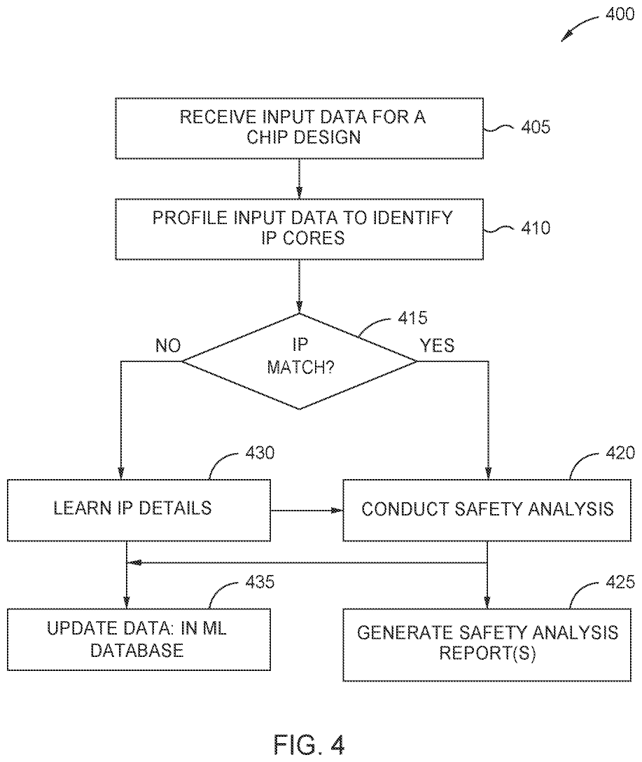

FIG. 4 depicts an exemplary simplified flow diagram 400 for a functional safety manager software tool operating on a computing system (such as computing system 900 of FIG. 9), also referred to herein as a functional safety system. At 405 of flow diagram 400, the functional safety manager software tool receives input data for a chip design, the chip having been designed by one or more upstream software tools. The input data is received from one or both of: a human user via a user interface, or directly from an upstream software tool. In some embodiments, the functional safety manager software tool may also receive at 405 broader project data, such as information regarding the constituent blocks that are connected together for the chip, and/or safety related functions that are to be performed by the chip that is being designed by software tools of the present disclosure.

The functional safety manager software tool then profiles the input data at 410 to identify the constituent IP cores that make up the chip design, from the input data. In some embodiments, only the IP cores that have safety related functions are profiled. In other embodiments, all IP cores of the chip design are profiled, whether they are safety related or not.

In exemplary embodiments, profiling is a built-in native task for the functional safety manager software tool that runs on the data extracted by a design analysis tool, such as a formal analysis and/or synthesis tool used in a chip design process. The data is extracted by the design analysis tool based on existing examples or images of RTL/analog structures that address the particular safety measures or types of safety measures that are desired in a chip design under evaluation by flow diagram 400.

As part of the profiling, the functional safety manager software tool may retrieve IP tag(s) and some or all safety related fields or attributes from the data structure (such as data structure 100 of FIG. 1), per the data structure of the profiled IP core. The functional safety system then determines at 415 if there is an IP match between the designed chip and an IP core's data stored at the data structure, based on the profiled tag and/or parameter information. That is, the functional safety system identifies any existing data structure matching fields between the received chip design and the stored data structure, based on parameter choices. The data structure in the database should match some or all the attributes/fields inside the IP core by at least a threshold amount, where the threshold amount is a configurable value. If there is a match, then the parameters are read into the functional safety system from the data structure. Then the functional safety system conducts one or more safety analyses at 420. Optionally, the functional safety system also creates the metrics that define the functional safety performance of the input chip design. The functional safety system further generates one or more safety analysis reports at 425, with results of the safety analyses conducted at 420, and/or the created metrics. In some embodiments, functional safety system outputs a safety analysis report with metrics and a classification of performance (i.e., whether the design passes or fails a safety analysis).

If the functional safety system determines at 415 that there is no IP match to a data structure in the database, or an insufficient match because some design blocks of the IP are missing or have different information, then the functional safety system learns the details of the IP at 430. Subsequently, the system updates the data structure at 435 with the specified new or updated information for the profiled IP core(s), including, in some embodiments, the functional safety performance metrics of the IPs validated in the context of the chip or application.

The functional safety system undergoes a learning process to bring the IP information into the database. That is, the functional safety system builds the data structure for the database and data points of the type of structure that the database has for the other IP cores. Substantially simultaneously to the learning process of 430, the functional safety system conducts the one or more safety analyses of 420. Thus, while a safety analysis can still be conducted for an IP that was not previously in the database, it may take longer to run through the algorithm to get the results. Further, the system may optionally send safety analysis results to the data structure, such that the results are associated with this new type of data, block, IP, etc.

A safety analysis report may have results in the form of metrics, which are parameters. A safety analysis report may have information regarding one or more of a single point fault metric, or a latent fault metric. These parameters show an ability of the IP to address random faults occurring in the field and related Failure Modes, identify them, and control them. If the faults can be first identified with high confidence, then the faults can be controlled.

A single point fault metric is a metric for faults that only require single fault to occur which violates one or several safety requirements. A latent fault is a fault that occurs, but does not affect any safety requirements by itself, until a second or more faults occurs, that in combination cause a failure leading to a safety requirement violation. It is important to detect latent faults because they may appear in the safety mechanisms of an automobile, or in the circuits that are an undetected fraction of its assigned safety mechanism. For example, if a safety goal is to keep a vehicle traveling within a lane boundary, a safety mechanism will recognize that a lane marking was traversed and apply a correction. However, if a system is not able to recognize that a lane marking was traversed in a first instance, that in itself does not cause a problem while the vehicle is traveling. It is only when the system fails to execute the safety mechanism check again or continuously for correction or alarm regarding a lane departure (and a consequence such as an accident occurs) that the first fault is detected. A latent fault metric describes an ability of the IP system to detect such latent faults. Ideally, the latent faults are detected 100% of the time.

These metrics are the result of the functional safety analysis and take into account how performant the safety mechanisms are. That is, some or all of the metrics represent whether there was sufficient diagnostic coverage, how one or more safety mechanisms reacted as a result of the fault(s), how the safety mechanisms addressed the predefined safety goals, and whether the safety mechanisms are sufficient for the desired level of fault detection and control.

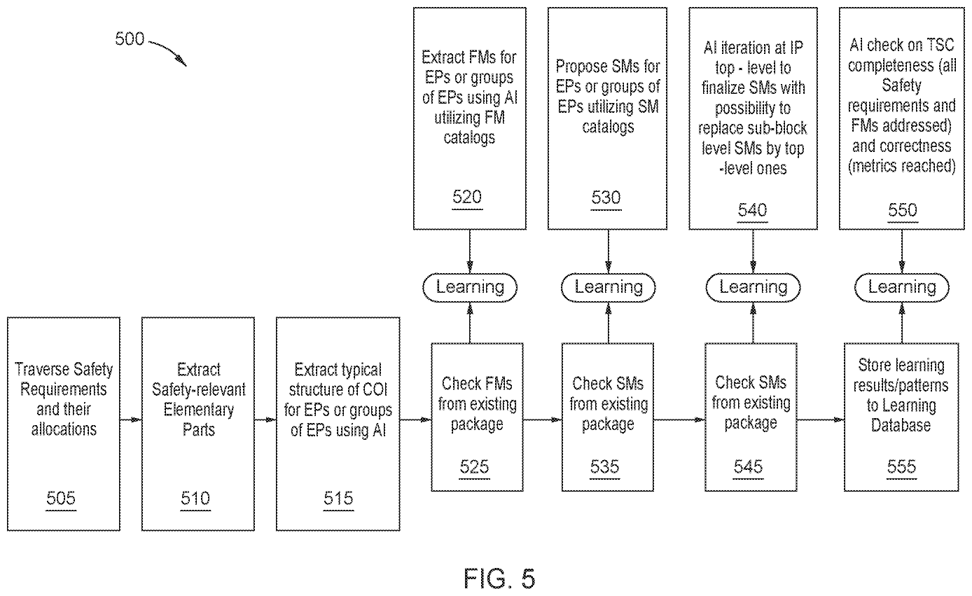

FIG. 5 depicts an exemplary learning workflow 500 for a functional safety software tool operating on a computing system (such as computing system 900 of FIG. 9), also referred to herein as a functional safety system, to learn new safety related information. While specific steps are depicted in exemplary workflow 500, there may be fewer or additional steps in other embodiments.

At 505 of workflow 500, the functional safety system traverses one or more of top-level safety requirements or technical safety requirements to identify the requirements that define the desired functional safety performance. Top-level safety requirements may be allocated to functions, or functional properties of the broader system or individual component. Technical safety requirements further refine the top-level safety requirements with the architectural details of the system or component. For example, technical safety requirements may be allocated to a data input register of the component.

The traversed information may come from another software tool, from data input through a user interface, or any combination thereof. At 510, the functional safety system extracts safety-related elementary parts (EPs) from the IP design structure. EPs are interface outputs and internal memory elements, for example flip-flops. In one example, design blocks of an IP core may have safety related designations such as SR1 or SR0 that denotes if they have a safety-related contribution or not. As used herein, an elementary part may be any sub-block of an IP. In some examples, an elementary part is any component of a circuit, including, but not limited to, a register, arithmetic unit (for combinational logic), counter, voltage reference, comparator, capacitor, transistor, and/or a resistor.

In one example, an elementary part may be a capacitor in a circuit, which by itself may not have any functional safety role, so it would be considered non-safety related. However, the capacitor may act as a memory device in a register that holds critical data for a functional safety parameter, thus making it functional safety-related in some embodiments. In this scenario, it may be desirable to have multiple registers in parallel so that if one fails, the others still contain the correct information.

At 515 of workflow 500, the system extracts a structure of cone of influence (COI) for EPs, or groups of EPs, using artificial intelligence method(s). In various embodiments, the structure for an EP or group of EPs is extracted based on information in a safety related data structure (such as data structure 100 of FIG. 1). In some examples, this learning step occurs between 325 and 330 of FIG. 3.

At 520 of workflow 500, the system extracts failure modes for the EPs or groups of EPs of the IP design using artificial intelligence methods utilizing reference failure mode catalog(s). That is, one or more failure mode catalogs contain information regarding some or all potential failure modes. The system may extract information regarding which particular failure modes from the catalog are relevant or applicable to the EP or group of EPs that are present in a particular IP design. In other words, the system compares the failure modes present in the catalog to the failure modes present in one or more elementary part component(s), and determines which failure mode(s) from the catalog are applicable to the present elementary parts.

In one example, an IP design has an elementary part of a register with a structure of the register being 16 bit latches. The register is a cell that latches information inside temporarily (i.e., stores data in a volatile state). The register delivers information to an output, either synchronously or asynchronously to a clock. When a clock pulses, new data from a data bus is read and data in the latch is replaced with the new data from the bus. For this example elementary part and data structure, the system will reference the FM catalog. In some embodiments, the catalog may have a category for registers, and another category for latches. The catalog may define a failure mode for these components to be a scenario where the latch cannot read data from the data bus because it is disconnected from the bus somewhere. The catalog may further define a second failure mode for these components to be a scenario where the latch cannot hold (store) data even if the clock is not pulsing. The catalog may additionally define a third failure mode for these components to be a scenario where the values in the storage elements change randomly.

The system further utilizes the reference failure mode catalog using artificial intelligence methods, including algorithms. In one embodiment, the system uses natural language processing (NLP) to identify a keyword that describes an elementary part of the IP design. For example, a keyword may be ‘register’, or ‘latch’. The system may then search the FM catalog for the keyword(s) to identify failure mode(s) for the EPs. Each of the identified FMs for the identified keywords may further be stored into the learning database and associated with the elementary part(s). If an elementary part cannot be identified for the IP design but the IP design has a behavioral or structural description (such as a netlist or RTL), then a neural network, such as a convolutional neural network (CNN) or recursive neural network (RNN), is used to identify what components may be required to meet the behavioral or structural description for the IP design. That is, the neural network determines whether a netlist will have a register, logic unit, or other components, and the keyword(s) for the elementary parts that will be needed. These keywords can then be used by the system to identify potential failure modes from an FM catalog.

At 525 of workflow 500, the system checks failure modes (FMs) from one or more existing IP designs in the data store (i.e., the learning database), to determine a match with the failure modes extracted from a present IP block's EP or group of EPs determined in 515. In some embodiments, the one or more existing designs in the data store are from one or more prior designs composed or analyzed by the system. In some embodiments, one of 520 and 525 is performed by the system only if a FM extracted from an elementary part is not present in the data store already. In other embodiments, both 520 and 525 are performed by the system even if the FM extracted from an elementary part is present in an existing design. Each of the relevant failure modes for the elementary parts of the IP block (whether learned from an existing design or an FM catalog) is learned by the system and incorporated into the data store, if not already present therein.

At 530 of workflow 500, the system proposes SMs for the EPs or groups of EPs utilizing reference SM catalog(s). That is, one or more SM catalogs may contain information regarding some or all potential SMs associated with the EPs or groups of EPs that are present in the IP design. The system may extract information regarding which particular SMs from the catalog are relevant or applicable to the EP or group of EPs that are present in a particular IP design based on the failure modes. In other scenarios where safety mechanisms already exist, the system compares the SMs present in the catalog to the SMs present in the elementary part components, and determines which SMs from the catalog are applicable to the present elementary parts.

In one approach, safety mechanisms are implemented to address specific failure modes, and the failure modes are allocated to identified elementary parts. That is, the system has a way of failing, and the safety mechanism is designed to address that way of failing. In one example, a system may have a power failure in a component, where the power failure is a ‘failure mode’ for that component. A safety mechanism targeted to a method of addressing that specific failure mode (power failure) is identified or proposed at 530 of workflow 500. The failure mode catalog contains references between safety mechanisms and the failure modes they are addressing. These references are further used to allocate SMs to an elementary part of the IP design. In some embodiments, the system allocates SMs to elementary parts, based on one or more machine learning algorithms such as NLP, decision tree, and others.

At 535 of workflow 500, the system checks safety mechanisms (SMs) from one or more existing IP designs in the data store, to determine a match with the SMs extracted from a present IP block's EP or group of EPs determined in 515. In some embodiments, the one or more existing designs in the data store are from one or more prior designs composed or analyzed by the system. In some embodiments, one of 530 and 535 is performed by the system only if a SM extracted from an elementary part is not present in the data store already. In other embodiments, both 530 and 535 are performed by the system even if the SM extracted from an elementary part is present in existing designs. Each of the relevant safety mechanisms for the elementary parts of the IP block (whether learned from an existing design or an SM catalog) is learned by the system and incorporated into the data store, if not already present therein.

At 540 of workflow 500, the system performs an AI iteration at a top-level of the IP block to finalize the safety mechanisms for the design, with a possibility of replacing sub-block level safety mechanisms by top-level safety mechanisms. By replacing sub-block level SMs with a single top-level SM, a global SM is defined for the IP block. This is advantageous because in some safety analyses (such as FMEDA), safety mechanisms can be defined in a global manner for an IP, rather than individually per sub-block of an IP.

Further, the system performs an artificial intelligence iteration of the safety mechanisms to define the top-level SM for the IP design. In one example, an IP design has two elementary parts, each having two safety mechanisms. That is, elementary part A has safety mechanisms A1 and A2. Elementary part B has safety mechanisms B1 and B2. Safety mechanisms A1 and B1 may be different, but SMs A2 and B2 are the same. The system can identify this using an AI algorithm to combine the four original safety mechanisms into three safety mechanisms—A1, B1, and 2, where 2 represents an aggregation of A2 and B2 into a single SM. In some embodiments, the AI algorithm utilizes pattern recognition to identify the similarity between SMs A2 and B2 and know that these can be aggregated into a single SM.

In one specific example, a failure mode is a power failure of a component. A safety mechanism that may be allocated to this FM is use of a voltage monitor to monitor the power supply for a first elementary part, and trigger when a power failure occurs. Similarly, a voltage monitor may be deployed for a second elementary part, and trigger when a power failure occurs of that elementary part. The AI algorithm can evaluate this design, know that the power supply used by the first and second elementary parts is common, and thus if power fails at the first EP, it will also have failed at the second EP. As such, only one voltage monitor (safety mechanism) is needed to address this failure mode for both elementary parts. In this way, the SMs are aggregated.

In a second example, two elementary parts are each connected to a data bus. Each EP needs an error correction mechanism as a safety mechanism to address a data collection error (failure mode). Thus, in an original IP design, both elementary parts may have their own error correction code (ECC). However, the system can utilize AI iteration at 540 to determine that both elementary parts are connected to a common data bus at a top level. As such, only one error correction code is necessary for the two EPs. That is, the AI algorithm determines that there are identical needs that can be addressed through one aggregated SM.

In this way, 540 is a processing step whereby the SMs allocated to EPs are aggregated as needed at the IP component level. In some embodiments, the AI algorithms use pattern recognition via one or more of a convolutional neural network or recursive neural network to determine if SMs are similar enough to be aggregated. This process can be conducted iteratively through each level of hierarchy for an IP design.

At 545 of workflow 500, the system optionally checks one or more of the proposed SMs from 535 with one or more existing designs in the data store, to determine a match of the top-level SM defined at 540. In some embodiments, the one or more existing designs in the data store are from one or more prior designs composed or analyzed by the system. In some embodiments, one of 540 and 545 is performed by the system only if the top-level SM is not present in the data store already. In other embodiments, both 540 and 545 are performed by the system even if the top-level SM is present in existing designs. The defined top-level SM, whether learned from an existing design or an SM catalog, is learned by the system and incorporated into the data store, if not already present therein.

At 550 of workflow 500, the system conducts an AI check on technical safety concept (TSC) completeness to verify that all safety requirements and failure modes have been addressed, and that the desired correct values for safety metrics have been reached. In various embodiments, TSC may include one or more of top-level safety requirements, technical safety requirements, failure modes, safety mechanisms, and results of select functional safety analyses. At block 550, the system checks that the designed IP meets the desired functional safety requirements by checking the value of calculated safety metrics. In one example, a final metric is determined that the IP design fits the original requirements of functional safety performance with a particular probability (for example 99% probability).

Technical safety concepts, also sometimes referred to herein as safety concepts (SC), ensure that top level safety requirements are accomplished with the desired performance metrics by the component or system. Technical safety concepts must find the technical solution to satisfy the top level safety performance with a certain quantified level of performance metric. AI methods can be used to demonstrate that the SMs that are implemented will actually address the top level safety requirements. In one embodiment, traceability of requirements is used to show this. Typically, requirements are traced in a top to bottom manner-that is starting from broader requirements to the specific technical implemented solution. In embodiments of the present disclosure, the requirements are also traced back from bottom to top. That is, from SM to FM to EP that is doing the function that is subject to the top level safety requirements. This traceability ensures that the implemented solution actually addresses the top level safety requirements. The AI algorithm can then confirm that the specific IP design solution, with its metrics, addresses the top level safety requirements. This can be confirmed due to the information present in the learning database that shows that this particular solution has been previously demonstrated to satisfy these particular requirements. The AI algorithm recognizes that the IP design matches a pattern in the learning database, and thus can confirm that the designed solution was properly implemented because it is recognized as a pattern that is already proven (from the database). If the pattern is not recognized as already being present in the learning database, then the system will confirm it through one or more safety analyses, and add it to the learning database so it is present for next time.

The results and/or patterns from 550 are then stored to the machine learning data store at 555.

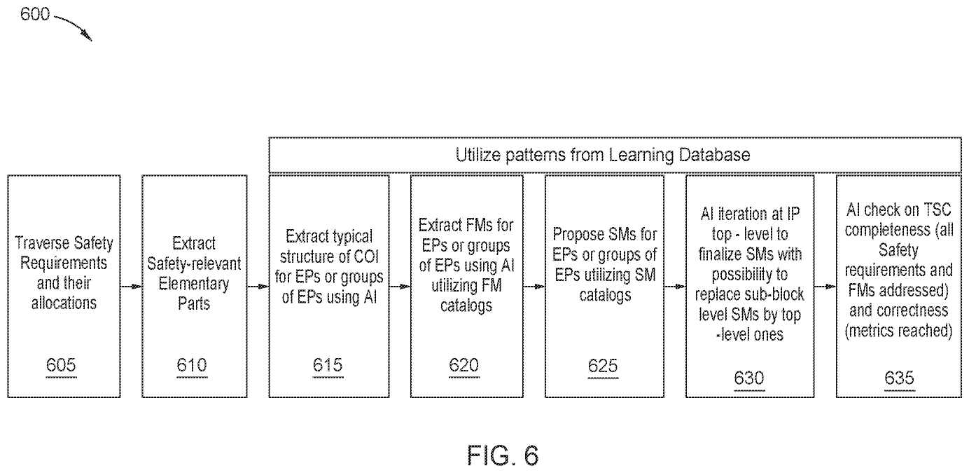

FIG. 6 depicts an exemplary inference workflow 600 for a functional safety software tool operating on a computing system (such as computing system 900 of FIG. 9), also referred to herein as a functional safety system, to utilize existing database information to process a technical safety concept. While specific steps are depicted in exemplary workflow 600, there may be fewer or additional steps in other embodiments.

At 605 of workflow 600, the functional safety system traverses one or more of top-level safety requirements or technical safety requirements to identify the requirements that define the desired functional safety performance, in a similar process to 505 of workflow 500 in FIG. 5. The traversed information may come from another software tool, from data input through a user interface, or any combination thereof. At 610, the functional safety system extracts safety-related elementary parts (EPs) from the safety requirement information, in a similar process to 510 of workflow 500 in FIG. 5. In one example, design blocks of an IP core may have safety related designations such as SR1 or SR0 that denotes if they have a safety-related contribution or not.

At 615 of workflow 600, the system extracts a structure for EPs, or groups of EPs, using artificial intelligence method(s). In various embodiments, the structure for an EP or group of EPs is extracted based on information in a safety related data structure (such as data structure 100 of FIG. 1), in a similar process to 515 of workflow 500 in FIG. 5.

At 620 of workflow 600, the system extracts failure modes for the EPs or groups of EPs using artificial intelligence utilizing failure mode catalogs, in a similar process to 520 of workflow 500 in FIG. 5. That is, one or more failure mode catalogs may contain information regarding potential failure modes. The system may extract information regarding which particular failure modes from the catalog are relevant or applicable to the EP or group of EPs. At 625 of workflow 600, the system proposes SMs for the EPs or groups of EPs using artificial intelligence utilizing SM catalogs, in a similar process to 530 of workflow 500 in FIG. 5. That is, one or more SM catalogs may contain information regarding potential SMs. The system may extract information regarding which particular SMs from the catalog are relevant or applicable to the EP or group of EPs.

At 630 of workflow 600, the system performs an AI iteration at a top-level of the IP core to finalize the safety mechanisms for the design, with a possibility of replacing sub-block level safety mechanisms by top-level safety mechanisms, in a similar process to 540 of workflow 500 in FIG. 5. At 635, the system conducts an AI check to verify that all safety requirements and failure modes have been addressed, and that the desired correct values for safety metrics have been reached, in a similar process to 550 of workflow 500 in FIG. 5.

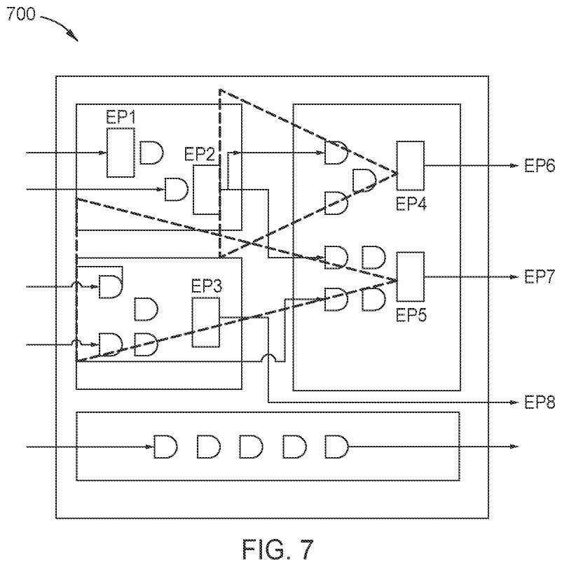

FIG. 7 depicts an exemplary simplified graphic 700 of operations performed by a functional safety system, including blocks 605 and 610 of FIG. 6, and blocks 505 and 510 of FIG. 5. Graphic 700 depicts that a functional safety system will traverse a provided circuit design and identify which inputs in the circuit are affecting which outputs of the circuit. Thus, cones of influence are identified, and denoted by the triangles in graphic 700.

The cones of influence can then be used to identify blocks and functions of the circuit, and help identify the elementary parts of the circuit, denoted in graphic 700 as EP1 through EP8. The functional safety software can automatically identify the design blocks and the elementary parts and match them with what is already present in the database. If they are not present in the database, then the database can learn about the identified design blocks and elementary parts. In this way, the functional safety system can identify parts like combinational logic for adding information, logic functions such as “and” or “or”, registers that can hold information, sets of register cells that can shift information, and others.

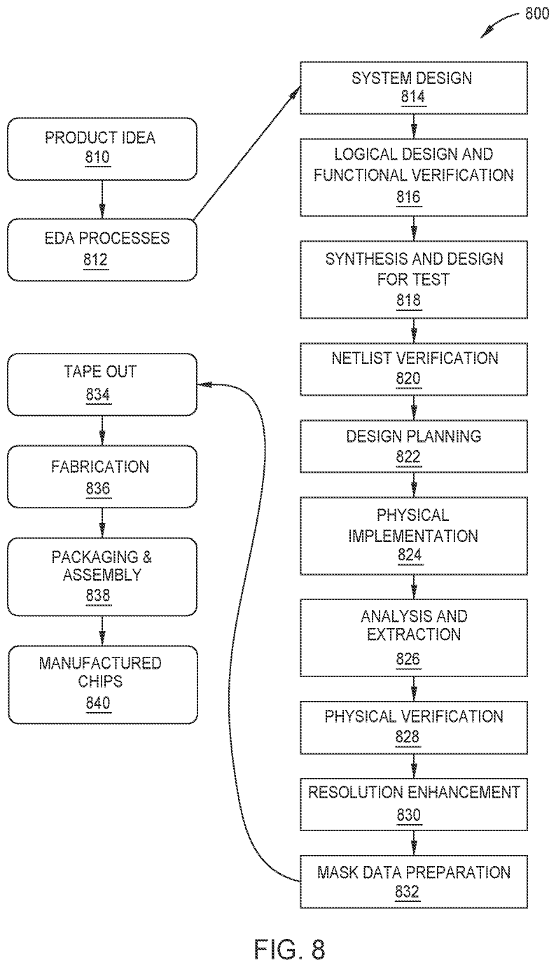

FIG. 8 illustrates an example set of processes 800 used during the design, verification, and fabrication of an article of manufacture such as an integrated circuit to transform and verify design data and instructions that represent the integrated circuit. Each of these processes can be structured and enabled as multiple modules or operations. The term ‘EDA’ signifies the term ‘Electronic Design Automation.’ These processes start with the creation of a product idea 810 with information supplied by a designer, information which is transformed to create an article of manufacture that uses a set of EDA processes 812. When the design is finalized, the design is taped-out 834, which is when artwork (e.g., geometric patterns) for the integrated circuit is sent to a fabrication facility to manufacture the mask set, which is then used to manufacture the integrated circuit. After tape-out, a semiconductor die is fabricated 836 and packaging and assembly processes 838 are performed to produce the finished integrated circuit 840.

Specifications for a circuit or electronic structure may range from low-level transistor material layouts to high-level description languages. A high-level of representation may be used to design circuits and systems, using a hardware description language (‘HDL’) such as VHDL, Verilog, System Verilog, Verilog-AMS, SystemC, MyHDL or OpenVera. The HDL description can be transformed to a logic-level register transfer level (‘RTL’) description, a gate-level description, a layout-level description, or a mask-level description. Each lower representation level that is a more detailed description adds more useful detail into the design description, for example, more details for the modules that include the description. The lower levels of representation that are more detailed descriptions can be generated by a computer, derived from a design library, or created by another design automation process. An example of a specification language at a lower level of representation language for specifying more detailed descriptions is SPICE, which is used for detailed descriptions of circuits with many analog components. Descriptions at each level of representation are enabled for use by the corresponding systems of that layer (e.g., a formal verification system). A design process may use a sequence depicted in FIG. 8. The processes described may be enabled by EDA products (or EDA systems).

During system design 814, functionality of an integrated circuit to be manufactured is specified. The design may be optimized for desired characteristics such as power consumption, performance, area (physical and/or lines of code), and reduction of costs, etc. Partitioning of the design into different types of modules or components can occur at this stage.

During logic design and functional verification 816, modules or components in the circuit are specified in one or more description languages and the specification is checked for functional accuracy. For example, the components of the circuit may be verified to generate outputs that match the requirements of the specification of the circuit or system being designed. Functional verification may use simulators and other programs such as testbench generators, static HDL checkers, and formal verifiers. In some embodiments, special systems of components referred to as ‘emulators’ or ‘prototyping systems’ are used to speed up the functional verification.

During synthesis and design for test 818, HDL code is transformed into a netlist. In some embodiments, a netlist may be a graph structure where edges of the graph structure represent components of a circuit and where the nodes of the graph structure represent how the components are interconnected. Both the HDL code and the netlist are hierarchical articles of manufacture that can be used by an EDA product to verify that the integrated circuit, when manufactured, performs according to the specified design. The netlist can be optimized for a target semiconductor manufacturing technology. Additionally, the finished integrated circuit may be tested to verify that the integrated circuit satisfies the requirements of the specification.

During netlist verification 820, the netlist is checked for compliance with timing constraints and for correspondence with the HDL code. During design planning 822, an overall floor plan for the integrated circuit is constructed and analyzed for timing and top-level routing.

During layout or physical implementation 824, physical placement (positioning of circuit components such as transistors or capacitors) and routing (connection of the circuit components by multiple conductors) occurs, and the selection of cells from a library to enable specific logic functions can be performed. As used herein, the term ‘cell’ may specify a set of transistors, other components, and interconnections that provides a Boolean logic function (e.g., AND, OR, NOT, XOR) or a storage function (such as a flipflop or latch). As used herein, a circuit ‘block’ may refer to two or more cells. Both a cell and a circuit block can be referred to as an elementary part, a module or component, and are enabled as both physical structures and in simulations. Parameters are specified for selected cells (based on ‘standard cells’) such as size and made accessible in a database for use by EDA products.

During analysis and extraction 826, the circuit function is verified at the layout level, which permits refinement of the layout design. During physical verification 828, the layout design is checked to ensure that manufacturing constraints are correct, such as DRC constraints, electrical constraints, lithographic constraints, and that circuitry function matches the HDL design specification. During resolution enhancement 830, the geometry of the layout is transformed to improve how the circuit design is manufactured.

During tape-out, data is created to be used (after lithographic enhancements are applied if appropriate) for production of lithography masks. During mask data preparation 832, the ‘tape-out’ data is used to produce lithography masks that are used to produce finished integrated circuits.

A storage subsystem of a computer system (such as computer system 900 of FIG. 9) may be used to store the programs and data structures that are used by some or all of the EDA products described herein, and products used for development of cells for the library and for physical and logical design that use the library.

FIG. 9 illustrates an example machine of a computer system 900 within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 900 includes a processing device 902, a main memory 904 (e.g., read-only memory (ROM), flash memory, dynamic random access memory (DRAM) such as synchronous DRAM (SDRAM), a static memory 906 (e.g., flash memory, static random access memory (SRAM), etc.), and a data storage device 918, which communicate with each other via a bus 930.

Processing device 902 represents one or more processors such as a microprocessor, a central processing unit, or the like. More particularly, the processing device may be complex instruction set computer (CISC) microprocessor, reduced instruction set computer (RISC) microprocessor, very long instruction word (VLIW) microprocessor, or a processor implementing other instruction sets, or processors implementing a combination of instruction sets. Processing device 902 may also be one or more special-purpose processing devices such as an application specific integrated circuit (ASIC), a field programmable gate array (FPGA), a digital signal processor (DSP), network processor, or the like. The processing device 902 may be configured to execute instructions 926 for performing the operations and steps described herein.

The computer system 900 may further include a network interface device 908 to communicate over the network 920. The computer system 900 also may include a video display unit 910 (e.g., a liquid crystal display (LCD) or a cathode ray tube (CRT)), an alphanumeric input device 912 (e.g., a keyboard), a cursor control device 914 (e.g., a mouse), a graphics processing unit 922, a signal generation device 916 (e.g., a speaker), graphics processing unit 922, video processing unit 928, and audio processing unit 932.

The data storage device 918 may include a machine-readable storage medium 924 (also known as a non-transitory computer-readable medium) on which is stored one or more sets of instructions 926 or software embodying any one or more of the methodologies or functions described herein. The instructions 926 may also reside, completely or at least partially, within the main memory 904 and/or within the processing device 902 during execution thereof by the computer system 900, the main memory 904 and the processing device 902 also constituting machine-readable storage media.

In some implementations, the instructions 926 include instructions to implement functionality corresponding to the present disclosure. While the machine-readable storage medium 924 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine and the processing device 902 to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm may be a sequence of operations leading to a desired result. The operations are those requiring physical manipulations of physical quantities. Such quantities may take the form of electrical or magnetic signals capable of being stored, combined, compared, and otherwise manipulated. Such signals may be referred to as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the present disclosure, it is appreciated that throughout the description, certain terms refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may include a computer selectively activated or reconfigured by a computer program stored in the computer. Such a computer program may be stored in a computer readable storage medium, such as, but not limited to, any type of disk including floppy disks, optical disks, compact disk read-only memory (CD-ROMs), and magnetic-optical disks, read-only memories (ROMs), random access memories (RAMs), erasable programmable read-only memories (EPROMs), electrically erasable programmable read-only memories (EEPROMs), magnetic or optical cards, or any type of media suitable for storing electronic instructions, each coupled to a computer system bus.

The algorithms and displays presented herein are not inherently related to any particular computer or other apparatus. Various other systems may be used with programs in accordance with the teachings herein, or it may prove convenient to construct a more specialized apparatus to perform the method. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. Where the disclosure refers to some elements in the singular tense, more than one element can be depicted in the figures and like elements are labeled with like numerals. The disclosure and drawings are, accordingly, to be regarded in an illustrative sense rather than a restrictive sense.

What is claimed is:

1. A computer-implemented method comprising:
receiving identification information for an IP core, the identification information for the IP core comprising at least one of: an IP tag, and a pointer to a location where the identification information for the IP core is stored in a data structure;
determining that at least one safety related parameter for the IP core is present in the data structure;
determining that the at least one safety related parameter for the IP core matches the identification information in the data structure within a threshold;
using the IP information in the data structure to conduct a safety analysis; and
generating a safety report with a result of the safety analysis.

2. The method of claim 1, wherein the data structure is a machine learning database.

3. The method of claim 1, wherein the threshold of IP information in the data structure is a customizable threshold.

4. The method of claim 1, wherein the pointer to IP information in the data structure is in dot notation.

5. The method of claim 1, wherein the safety-related parameter is a parameter used in an analysis under ISO 26262 standard.

6. The method of claim 1, wherein the safety analysis is one or more of: a failure modes effects and diagnostic analysis (FMEDA), a dependent failure analysis (DFA) or a fault tree analysis (FTA).

7. The method of claim 1, further comprising: updating at least one functional safety metric in the safety related data structure for the matched at least one identified IP core, based on a result of the conducted safety analysis.

8. A non-transitory computer readable medium comprising stored instructions, which when executed by a processor, cause the processor to:
determine a safety requirement for an IP core design;
extract at least one safety-related elementary part from the IP core design;
extract at least one failure mode for the safety-related elementary part from a failure mode catalog;
propose at least one safety mechanism for the safety-related elementary part using a safety mechanism catalog;
aggregate the proposed at least one safety mechanisms into an aggregate safety mechanism for the IP core design;
conduct a safety concept (SC) check to verify that a quantitative performance metric is within a desired threshold.

9. The non-transitory computer readable medium of claim 8, wherein the processor is further configured to extract the at least one failure mode for the safety-related elementary part from the failure mode catalog using at least one of natural language processing or a neural network.

10. The non-transitory computer readable medium of claim 8, wherein the processor is further configured to:
train a machine learning database to associate the extracted at least one failure mode with the extracted at least one safety-related elementary part, the training based in part on the failure mode catalog.

11. The non-transitory computer readable medium of claim 8, wherein the processor is further configured to:
train a machine learning database to associate the proposed at least one safety mechanism with the extracted at least one failure mode for the safety-related elementary part, the training based in part on the safety mechanism catalog.

12. The non-transitory computer readable medium of claim 8, wherein the processor is further configured to:
train a machine learning database to associate the aggregate safety mechanism with the extracted at least one safety-related elementary part, the training based in part on the safety mechanism catalog.

13. The non-transitory computer readable medium of claim 8, wherein the processor is configured to aggregate the proposed at least one safety mechanisms into an aggregate safety mechanism for the IP core design using artificially intelligent pattern recognition.

14. The non-transitory computer readable medium of claim 8, wherein the processor is further configured to determine the safety requirement for the IP core design from a machine learning database.

15. The non-transitory computer readable medium of claim 8, wherein the SC check facilitates determining compliance with a design specific parameter that influences safety.

16. A system comprising:
a memory storing instructions; and
a processor, coupled with the memory and to execute the instructions, the instructions when executed cause the processor to:
receive input data for a chip design;
profile the input data to identify a plurality of IP cores present in the chip design;
determine a match of at least one identified IP core with a functional safety related data structure within at least a predefined threshold;
conduct one or more safety analyses on the at least one identified IP core;
update at least one functional safety metric in the safety related data structure for the matched at least one identified IP core based on a result of the conducted one or more safety analyses;
and
generate a safety report with a result of the one or more safety analyses.

17. The system of claim 16, wherein the functional safety related data structure is a machine learning database.

18. The system of claim 16, wherein the one or more safety analyses facilitate determining compliance with an ISO 26262 standard.

19. The system of claim 16, wherein the one or more safety analyses is one or more of: a failure modes effects and diagnostic analysis (FMEDA), a dependent failure analysis (DFA), or a fault tree analysis (FTA).

20. The system of claim 16, wherein the processor is further configured to profile the input data to identify at least one functional safety related IP core present in the chip design.
